(19) United States
(12) Patent Application Publication
(10) Pub. No.: US 2017/0251140 A1
(43) Pub. Date: Aug. 31, 2017

(54) Apparatus, Method, and Program Product for Capturing Video

(71) Applicant: Motorola Mobility LLC, Chicago, IL (US)

(72) Inventor: Mark A. Jasiuk, Chicago, IL (US)

(21) Appl. No.: 15/053,471

(22) Filed: Feb. 25, 2016

(51) Int. Cl. H04N 5/232; G03B 13/36; G02B 7/36

(52) U.S. Cl. CPC H04N 5/23212; G02B 7/36; G03B 13/36

(57) ABSTRACT

Apparatuses, methods, and program products are disclosed for capturing video. In one method, video is captured using a video capturing device. Moreover, capturing the video may include setting a focus of the lens to a first focus plane distance having a first predetermined focus plane distance range. Further, capturing the video may include determining an estimate of a second focus plane distance. Capturing the video may also include determining whether the estimate of the second focus plane distance is outside of the first predetermined focus plane distance range. In addition, capturing the video may include adjusting the focus of the lens of the video capturing device in response to the estimate of the second focus plane distance being outside of the first predetermined focus plane distance range.

### BACKGROUND

Field

The subject matter disclosed herein relates to capturing video and more particularly relates to lens focusing while capturing video.

Description of the Related Art

Information handling devices, such as desktop computers, laptop computers, tablet computers, smart phones, optical head-mounted display units, smart watches, cameras, etc., are ubiquitous in society. Such information handling devices may be used to capture video. Autofocus performed while capturing video may change a focus of a lens excessively.

### BRIEF SUMMARY

An apparatus for capturing video is disclosed. A method and computer program product also perform the functions of the apparatus. In one embodiment, the apparatus includes a video capturing device having a lens, a processor, and a memory that stores code executable by the processor. The code, in various embodiments, is executable by the processor to capture a video using the video capturing device. In a further embodiment, capturing the video includes setting a focus of the lens to a first focus plane distance having a first predetermined focus plane distance range. In certain embodiments, capturing the video includes determining an estimate of a second focus plane distance. In some embodiments, capturing the video includes determining whether the estimate of the second focus plane distance is outside of the first predetermined focus plane distance range. In various embodiments, capturing the video includes adjusting the focus of the lens of the video capturing device in response to the estimate of the second focus plane distance being outside of the first predetermined focus plane distance range.

In some embodiments, setting the focus of the lens of the video capturing device to the first focus plane distance includes determining the first focus plane distance. In one embodiment, capturing the video includes adjusting a measure of acceptable sharpness used to determine the first predetermined focus plane distance range in response to historical data. In such an embodiment, the measure of acceptable sharpness may be a variable. In various embodiments, the variable may be a circle of confusion variable. In certain embodiments, the first predetermined focus plane distance range includes a near focus plane distance to a far focus plane distance. In various embodiments, the near focus plane distance and the far focus plane distance are determined based on the first focus plane distance. In some embodiments, determining the estimate of the second focus plane distance includes using phase detection to determine the estimate of the second focus plane distance.

A method for capturing video, in one embodiment, includes capturing a video using a video capturing device. In a further embodiment, capturing the video includes setting a focus of the lens to a first focus plane distance having a first predetermined focus plane distance range. In certain embodiments, capturing the video includes determining an estimate of a second focus plane distance. In some embodiments, capturing the video includes determining whether the estimate of the second focus plane distance is outside of the first predetermined focus plane distance range. In various embodiments, capturing the video includes adjusting the focus of the lens of the video capturing device in response to the estimate of the second focus plane distance being outside of the first predetermined focus plane distance range.

In some embodiments, capturing the video includes focusing the lens using autofocus. In various embodiments, a variable used to determine the first predetermined focus plane distance range is a circle of confusion variable. In one embodiment, capturing the video includes adjusting the variable in response to historical data. In certain embodiments, the first predetermined focus plane distance range includes a range from a near focus plane distance to a far focus plane distance. In such embodiments, the near focus plane distance and the far focus plane distance may be determined using a lookup table.

In some embodiments, determining the estimate of the second focus plane distance includes not adjusting the focus of the lens. In various embodiments, determining the estimate of the second focus plane distance includes using phase detection to determine the estimate of the second focus plane distance. In certain embodiments, adjusting the focus of the lens of the video capturing device includes adjusting the focus of the lens based on the estimate of the second focus plane distance. In one embodiment, the first and second focus plane distances are determined by detecting a distance between the lens of the video capturing device and one or more of a selected person and a selected object. In such an embodiment, the focus of the lens may not change if the one or more of the selected person and the selected object is outside of a lens field of view.

In one embodiment, a program product includes a computer readable storage medium that stores code executable by a processor. The executable code, in certain embodiments, includes code to perform capturing a video using a video capturing device. In a further embodiment, capturing the video includes setting a focus of the lens to a first focus plane distance having a first predetermined focus plane distance range. In certain embodiments, capturing the video includes determining an estimate of a second focus plane distance. In some embodiments, capturing the video includes determining whether the estimate of the second focus plane distance is outside of the first predetermined focus plane distance range. In various embodiments, capturing the video includes adjusting the focus of the lens of the video capturing device in response to the estimate of the second focus plane distance being outside of the first predetermined focus plane distance range.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of an apparatus including an information handling device;

FIG. 2 is a schematic block diagram illustrating one embodiment of an apparatus including a video capture module;

FIG. 3 is a schematic block diagram illustrating another embodiment of an apparatus including a video capture module;

FIG. 4 is a graph illustrating an embodiment a focus plane distance and a focus plane distance range;

FIG. 5 is a schematic flow chart diagram illustrating an embodiment of a method for capturing video; and

FIG. 6 is a schematic flow chart diagram illustrating another embodiment of a method for capturing video.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Certain of the functional units described in this specification have been labeled as modules, in order to more particularly emphasize their implementation independence. For example, a module may be implemented as a hardware circuit comprising custom very-large-scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. These code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

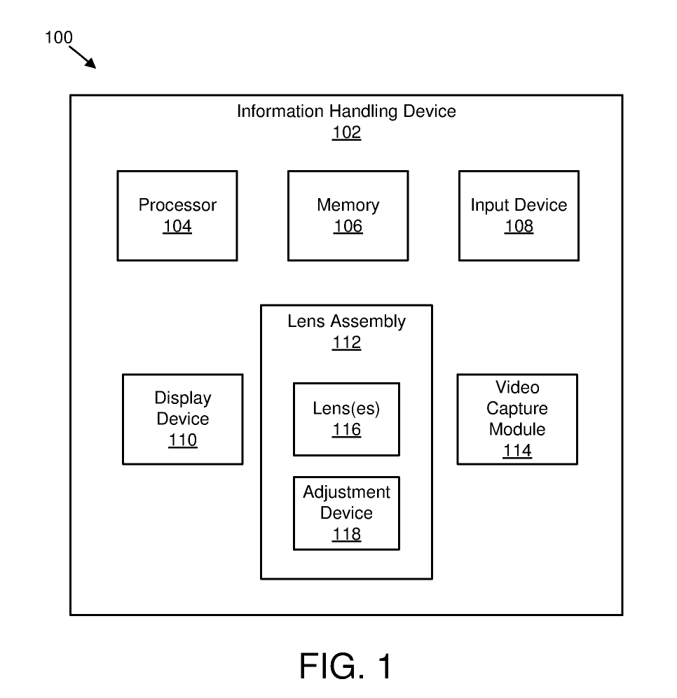

FIG. 1 depicts one embodiment of an apparatus 100 that may be used for capturing video. The apparatus 100 includes one embodiment of an information handling device 102. Furthermore, the information handling device 102 may include a processor 104, a memory 106, an input device 108, a display device 110, a lens assembly 112, and a video capture module 114. In some embodiments, the input device 108 and the display device 110 are combined into a single device, such as a touchscreen.

The processor 104, in one embodiment, may include any known controller capable of executing computer-readable instructions and/or capable of performing logical operations. For example, the processor 104 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 104 executes instructions stored in the memory 106 to perform the methods and routines described herein. The processor 104 is communicatively coupled to the memory 106, the input device 108, the display device 110, the lens assembly 112, and the video capture module 114.

The memory 106, in one embodiment, is a computer readable storage medium. In some embodiments, the memory 106 includes volatile computer storage media. For example, the memory 106 may include a RAM, including dynamic RAM (“DRAM”), synchronous dynamic RAM (“SDRAM”), and/or static RAM (“SRAM”). In some embodiments, the memory 106 includes non-volatile computer storage media. For example, the memory 106 may include a hard disk drive, a flash memory, or any other suitable non-volatile computer storage device. In some embodiments, the memory 106 includes both volatile and non-volatile computer storage media.

In some embodiments, the memory 106 stores data relating to video capture. In some embodiments, the memory 106 also stores program code and related data, such as an operating system or other controller algorithms operating on the information handling device 102.

The input device 108, in one embodiment, may include any known input device including a touch panel, a button, a keyboard, a stylus, or the like. In some embodiments, the input device 108 may be integrated with the display device 110, for example, as a touchscreen or similar touch-sensitive display. In some embodiments, the input device 108 includes a touchscreen such that video may be captured by touching the screen. In some embodiments, the input device 108 includes two or more different devices, such as a keyboard and a touch panel.

The display device 110, in one embodiment, may include any known electronically controllable display or display device. The display device 110 may be designed to output visual, audible, and/or haptic signals. In some embodiments, the display device 110 includes an electronic display capable of outputting visual data to a user. For example, the display device 110 may include, but is not limited to, an LCD display, an LED display, an OLED display, a projector, or similar display device capable of outputting images, text, or the like to a user. As another, non-limiting, example, the display device 110 may include a wearable display such as a smart watch, smart glasses, a heads-up display, or the like. Further, the display device 110 may be a component of a smart phone, a personal digital assistant, a television, a table computer, a notebook (laptop) computer, a personal computer, a vehicle dashboard, or the like.

In certain embodiments, the display device 110 includes one or more speakers for producing sound. For example, the display device 110 may produce an audible alert or notification (e.g., a beep or chime) upon capturing video. In some embodiments, the display device 110 includes one or more haptic devices for producing vibrations, motion, or other haptic feedback. For example, the display device 110 may produce haptic feedback upon capturing video.

In some embodiments, all or portions of the display device 110 may be integrated with the input device 108. For example, the input device 108 and display device 110 may form a touchscreen or similar touch-sensitive display. In other embodiments, the display device 110 may be located near the input device 108. In certain embodiments, the display device 110 may receive instructions and/or data for output from the processor 104 and/or the video capture module 114.

The lens assembly 112 may include any suitable type of camera lens 116 used to capture video. For example, the lens assembly 112 may include an optical lens 116 or an assembly of lenses 116 used to make images of objects that may be stored in the memory 106. In one embodiment, the lens assembly 112 includes multiple lenses 116 that are interchangeable with lenses of different focal lengths, apertures, and/or other properties. The lens assembly 112 may be used to focus the lens 116 by adjusting a distance from the lens 116 to an image plane by moving elements of the lens 116 using an adjustment device 118. Moreover, the adjustment device 118 may include any suitable device for moving elements of the lens 116 for focusing. As may be appreciated, the lens 116 may have a curvature.

The information handling device 102 may use the video capture module 114 for capturing video. As may be appreciated, the video capture module 114 may include computer hardware, computer software, or a combination of both computer hardware and computer software. For example, the video capture module 114 may include circuitry, or a processor, used to capture video. As another example, the video capture module 114 may include computer program code used to capture video.

In one embodiment, the video capture module 114 may capture video by setting a focus of the lens 116 of the information handling device 102 (e.g., a video capturing device) to a first focus plane distance having a first predetermined focus plane distance range. In another embodiment, the video capture module 114 may determine an estimate of a second focus plane distance. In certain embodiments, the video capture module 114 may determine whether the estimate of the second focus plane distance is outside of the first predetermined focus plane distance range. In various embodiments, the video capture module 114 may adjust the focus of the lens 116 of the information handling device 102 in response to the estimate of the second focus plane distance being outside of the first predetermined focus plane distance range. Accordingly, movement of the lens 116 may be reduced as compared to other methods for focusing the lens 116.

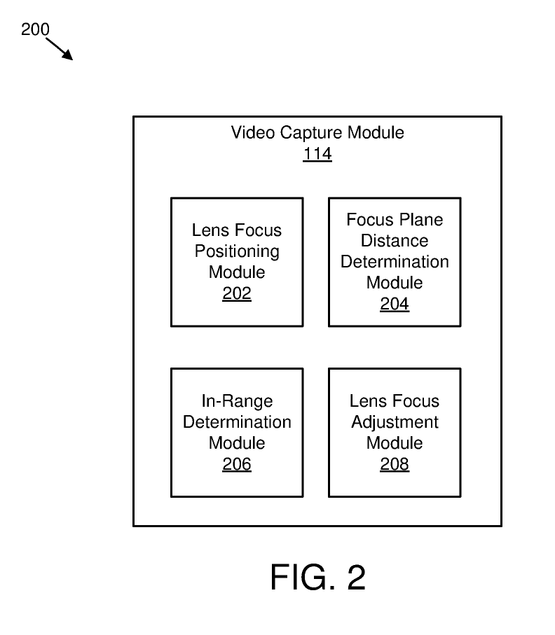

FIG. 2 depicts a schematic block diagram illustrating one embodiment of an apparatus 200 that includes one embodiment of the video capture module 114. Furthermore, the video capture module 114 includes a lens focus positioning module 202, a focus plane distance determination module 204, an in-range determination module 206, and a lens focus adjustment module 208 that are used to capture video.

In certain embodiments, the lens focus positioning module 202 sets a focus of the lens 116 to a focus plane distance having a predetermined focus plane distance range. In one embodiment, the lens focus positioning module 202 may use the adjustment device 118 to set the focus of the lens 116. As may be appreciated, a focus plane or plane of focus may represent a plane through an image, a person, an object, and/or a scene perpendicular to the axis of the lens 116 to which the lens is focused. Moreover, a focus plane distance may refer to a distance between the lens 116 and the focus plane. In certain embodiments, the lens 116 may have a field curvature. In such embodiments, the focus plane distance may refer to a distance between the lens 116 and an area in an image (e.g., the center) in which the lens 116 performance is the highest.

In some embodiments, the lens focus positioning module 202 determines the focus plane distance in order to set the focus of the lens 116 to the focus plane distance. The focus plane distance may be determined using any suitable method. For example, in one embodiment, the focus plane distance is a hyperfocal distance. In such an embodiment, the hyperfocal distance may be a distance beyond which all objects can be brought into an acceptable focus. One embodiment of a hyperfocal distance is a closest distance at which a lens may be focused while keeping objects at infinity acceptably sharp. When the lens is focused at this distance, objects at distances from half of the hyperfocal distance to an infinite distance may be acceptably sharp. Another embodiment of a hyperfocal distance is a distance beyond which all objects are acceptably sharp for a lens focused at infinity.

In one embodiment, the hyperfocal distance may be dependent on a level of sharpness that is considered acceptable. In certain embodiments, an acceptable level of sharpness may be specified by using a circle of confusion (“CoC”) limit. It should be noted that CoC may refer to an optical spot caused by a cone of light rays from a lens not coming to a perfect focus when imaging a point source.

In one embodiment, hyperfocal distance may be calculated using the formula:

$$H = \frac{{f}^{2}}{Nc} + f ,$$

where H is the hyperfocal distance, f is a focal length, N is an f-number (e.g., N=2^{i/2}, for i=1, 2, 3, and so forth corresponding to f1.4, f2, f2.8, and so forth), and c is the CoC limit. In certain embodiments, the hyperfocal formulation may be used to compute the near and far focus distance bounds, corresponding to a selected optimal focus distance s, which may be different from the hyperfocal distance H, for the selected value of c. That is, the sharpness of the image will be within the selected CoC value, and between the near focus plane distance and the far focus plane distance bounds, given by the hyperfocal formula, assuming that optimal focus plane distance is s, which may be expressed, for example, in millimeters. The hyperfocal formula for calculating the near focus plane distance bound may be given by:

$${D}_{n} = \frac{s ( H - f )}{H + s - 2 f} .$$

The hyperfocal formula for calculating the far focus plane distance may be given by:

$${D}_{f} = \frac{s ( H - f )}{H - s} .$$

Thus for any selected focus plane distance s, assuming to be optimal, and the circle of confusion limit c, the near and far focus distance bounds within which the image will be at least as sharp as the selected circle of confusion limit may be computed. In various embodiments, other methods of obtaining the near and far focus plane distance bounds may be employed, for example based on empirical measurements of the lens system.

In certain embodiments, the hyperfocal formula may be used to compute the near and far focus distance bounds, corresponding to a given focus distance to which the lens is set (which may be different from the hyperfocal distance H), for the selected value of c. That is, the sharpness of the image may be within the selected CoC value, and between the near focus plane distance bound and the far focus plane distance bound when the optimal focus plane distance is s, which may be expressed, for example, in millimeters. As may be appreciated, the near focus plane distance and/or the far focus plane distance may be determined using any suitable method, which may be different than the hyperfocal distance calculations presented. For example the near and far focus plane distance bounds may be selected, based on an empirical evaluation of a lens system, a lens system calibration, and so forth.

In another embodiment, hyperfocal distance may be calculated using the formula:

$$H = \frac{{f}^{2}}{Nc} ,$$

where H is the hyperfocal distance, f is a focal length, N is an f-number (e.g., f/D for an aperture diameter D), and c is the CoC limit. This formula may be exact if H is measured from a thin lens, or from the front principal plane of a complex lens. This formula may also be exact if H is measured from a point that is one focal length in front of the front principal plane. In certain embodiments, there may be little difference between the two hyperfocal distance formulas listed above.

As may be appreciated, by varying the CoC limit, the hyperfocal distance may change. Accordingly, in certain embodiments, the lens focus positioning module 202 may use a CoC variable to determine the predetermined focus plane distance range, while in various embodiments, the CoC may be constant. In some embodiments, the lens focus positioning module 202 may adjust the CoC variable in response to historical data. For example, the lens focus positioning module 202 may adjust the CoC variable to produce a sharper image if historical data shows that the focus of the lens 116 changes less than a predetermined frequency. In contrast, the lens focus positioning module 202 may adjust the CoC variable to produce a less sharp image if historical data shows that the focus of the lens 116 changes greater than a predetermined frequency.

In certain embodiments, the CoC variable may be varied in response to variance of the estimate of a focus plane distance. For example, a sequence of estimated focus plane distances indexed by time may be generated by a phase detect autofocus calculation. If the variance is high, the CoC variable may be relaxed (e.g., increased) to allow for more deviation from the estimated focus plane distance, before the focus distance is physically adjusted. Conversely, if the variance is low, indicating a relatively steady focus plane distance estimation over time, the CoC variable may be tightened (e.g., reduced), thereby resulting in a more precise setting of the focus distance. In some embodiments, relaxation or tightening may be applied to a measure of sharpness, which may be different than CoC. For example, a selected measure of sharpness, may be empirically determined for a lens system and/or through a lens system calibration. Moreover, in such embodiments, the selected measure of sharpness may be varied in response to historical data.

In some embodiments, the CoC variable may be varied as a function of the focus plane distance. For example, if the lens 116 is set to a close distance, the resulting depth of field (“DOF”) may be narrow, when compared to a focus plane distance set to an infinite distance. However, it is likely that an object being focused on is large within the frame, so focus precision may be relaxed with minimal perceived degradation in sharpness.

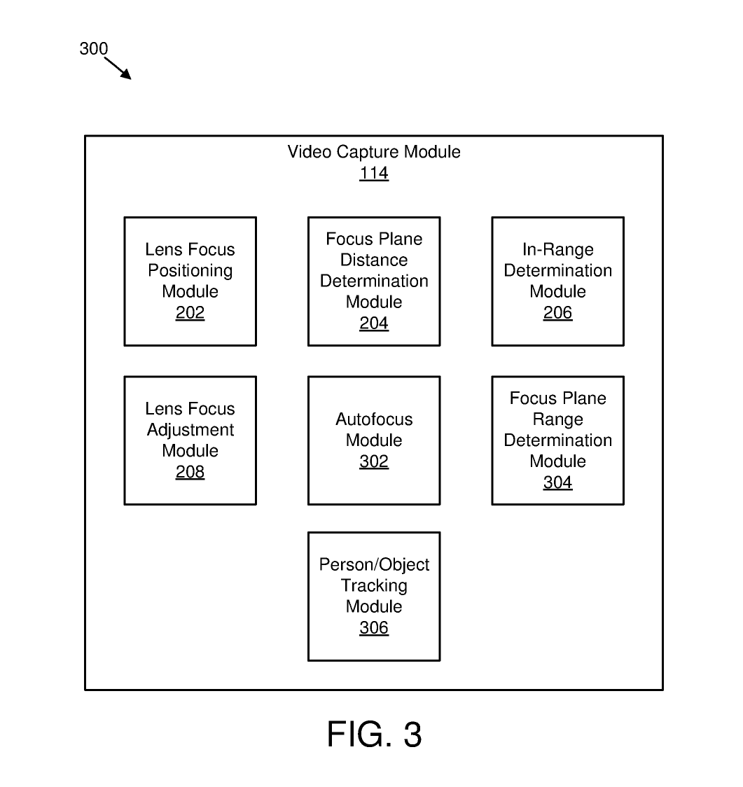

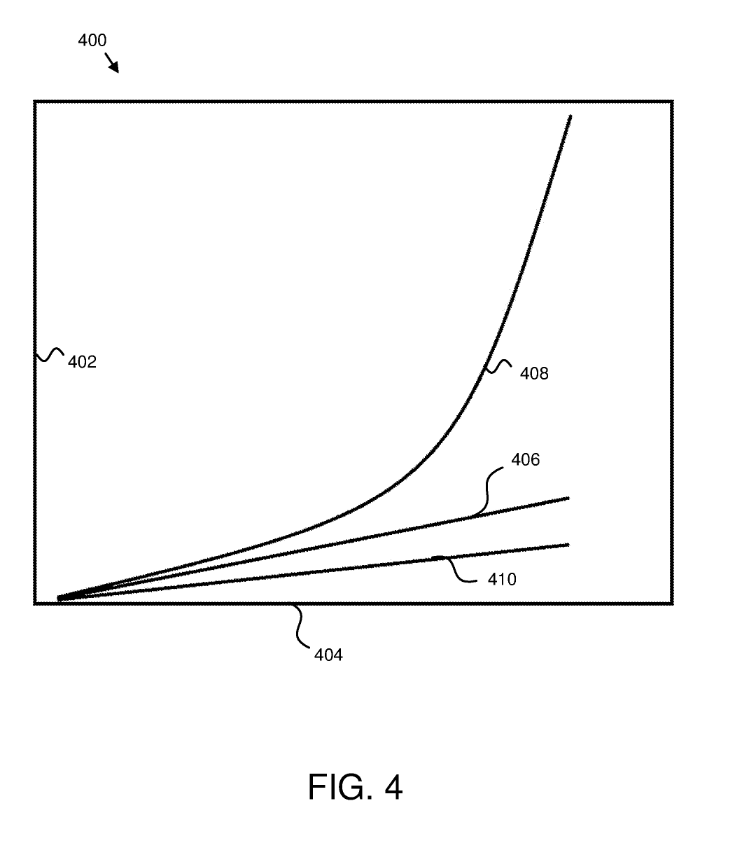

As may be appreciated, the predetermined focus plane distance range may be any suitable range. In one embodiment, the range may include distances bounded by a near focus plane distance and a far focus plane distance. The near focus plane distance may be, in some embodiments, approximately equal to ½ the hyperfocal distance. The far focus plane distance may be, in certain embodiments, infinity. The near focus plane distance and the far focus plane distance are discussed in greater detail in FIGS. 3 and 4.

In some embodiments, the focus plane distance determination module 204 determines an estimate of a focus plane distance. In certain embodiments, the focus plane distance determination module 204 may determine the estimate of the focus plane distance while capturing video, such as after setting the focus of the lens 116 to a focus plane distance and/or after an image captured by the lens 116 changes from when the focus of the lens 116 was set to the focus plane distance.

The focus plane distance may be determined using any suitable method. In some embodiments, the focus plane distance may be determined by calculating the hyperfocal distance, as discussed previously. In various embodiments, the focus plane distance determination module 204 may not adjust the focus of the lens 116 while determining the estimate of the focus plane distance. For example, in one embodiment, the focus plane determination module 204 may use phase detection to determine the estimate of the focus plane distance. In such an embodiment, light that enters the lens 116 is divided into pairs of images and compared in order to estimate the focus plane distance.

In one embodiment, the in-range determination module 206 determines whether the estimate of the focus plane distance is outside of the predetermined focus plane distance range. For example, the in-range determination module 206 may compare the estimate of the focus plane distance to a maximum of the predetermined focus plane distance range and/or a minimum of the predetermined focus plane distance range.

In one embodiment, the estimate of the focus plane distance may be outside of the predetermined focus plane distance range if the focus plane distance is greater than the maximum of the predetermined focus plane distance range or less than the minimum of the predetermined focus plane distance range. Conversely, the estimate of the focus plane distance may be within the predetermined focus plane distance range if the focus plane distance is less than or equal to the maximum of the predetermined focus plane distance range and greater than or equal to the minimum of the predetermined focus plane distance range. In another embodiment, the estimate of the focus plane distance may be outside of the predetermined focus plane distance range if the focus plane distance is greater than or equal to the maximum of the predetermined focus plane distance range or less than or equal to the minimum of the predetermined focus plane distance range. Conversely, the estimate of the focus plane distance may be within the predetermined focus plane distance range if the focus plane distance is less than the maximum of the predetermined focus plane distance range and greater than the minimum of the predetermined focus plane distance range.

In various embodiments, the lens focus adjustment module 208 adjusts the focus of the lens 116 of the information handling device 102 in response to the estimate of the focus plane distance being outside of the predetermined focus plane distance range. In contrast, in certain embodiments, the lens focus adjustment module 208 does not adjust the focus of the lens 116 of the information handling device 102 in response to the estimate of the focus plane distance being within the predetermined focus plane distance range. In some embodiments, the lens focus adjustment module 208 adjusts the focus of the lens 116 based on the estimate of the focus plane distance. As may be appreciated, the lens focus adjustment module 208 may use the adjustment device 118 to adjust the focus of the lens 116.

It should be noted that the focus plane distance determination module 204, the in-range determination module 206, and/or the lens focus adjustment module 208 may repeatedly perform their functions, such as with each change in an image detected by the lens 116, at predetermined intervals, and so forth. In certain embodiments, a new predetermined focus plane distance range may be determined after the focus of the lens 116 is adjusted. The new predetermined focus plane distance range may be used by the in-range determination module 206 to determine if a next focus plane distance is in range.

FIG. 3 is a schematic block diagram illustrating another embodiment of an apparatus 300 that includes one embodiment of the video capture module 114. Furthermore, the video capture module 114 includes one embodiment of the lens focus positioning module 202, the focus plane distance determination module 204, the in-range determination module 206, and the lens focus adjustment module 208, that may be substantially similar to the lens focus positioning module 202, the focus plane distance determination module 204, the in-range determination module 206, and the lens focus adjustment module 208 described in relation to FIG. 2. The video capture module 114 also includes an autofocus module 302, a focus plane range determination module 304, and a person/object tracking module 306.

In various embodiments, the autofocus module 302 focuses the lens 116 using autofocus. For example, the autofocus module 302 may perform focusing of the lens 116 without user input (e.g., automatically) while capturing video (e.g., video recording). Accordingly, the autofocus module 302 may focus the lens 116 as needed, such as based on when focusing of the lens 116 is to be performed as determined by the video capture module 114.

In certain embodiments, the focus plane range determination module 304 may be used to determine the predetermined focus plane distance range. In one embodiment, the predetermined focus plane distance range is a range that spans from a near focus plane distance to a far focus plane distance. In such an embodiment, the near focus plane distance and the far focus plane distance may be determined based on the current focus plane distance. For example, in one embodiment, if the lens focus is set to the hyperfocal distance H, the near focus plane distance is approximately ½ the current focus plane distance, while the far focus plane distance may be approximately infinity. In another embodiment, the near focus plane distance is approximately ½ the current focus plane distance. And in yet another embodiment, the far focus plane distance may be approximately infinity. As may be appreciated, the near focus plane distance and/or the far focus plane distance may be determined using any suitable method. It should be noted that the bounds of ½ the focus plane distance to infinity may work if the lens is set to the hyperfocal distance H. In such a case, the image sharpness may be no worse than the limit given by CoC, from ½ the hyperfocal distance to infinity.

In some embodiments, the near focus plane distance and the far focus plane distance are determined using a lookup table. For example, a lookup table may include focus plane distances, with each focus plane distance having a corresponding near focus plane distance and a corresponding far focus plane distance. In certain embodiments, distances not found in the lookup table may be interpolated from the distances found in the lookup table. In some embodiments, the lookup table may also include CoC values that correspond to the distances found in the lookup table. In one embodiment, there may be one lookup table for each CoC value. Thus, multiple instances of a lookup table may be stored, each corresponding to a preselected CoC value. In certain embodiments, multiple tables, with each table corresponding to a predefined measure of sharpness may be used. In such embodiments, the predefined measure of sharpness may be different than the hyperfocal bounds defined by CoC as previously discussed.

In some embodiments, the person/object tracking module 306 may be used to determine the focus plane distances. In one embodiment, the person/object tracking module 306 determines the focus plane distances by detecting a distance between the lens 116 of the information handling device 102 and one or more of a selected person and a selected object (e.g., or a plane in which the one or more of the selected person and the selected object resides). Moreover, the person/object tracking module 306 may use the distance between the lens 116 and the one or more of the selected person and the selected object to adjust the focus of the lens 116. As may be appreciated, the person/object tracking module 306 may detect and/or track the one or more of the selected person and the selected object. In certain embodiments, the focus of the lens does not change if the one or more of the selected person and the selected object is outside of a lens 116 field of view. It should be noted that field of view or field of vision may refer to an angle through which the lens 116 is able to detect images.

FIG. 4 is a graph illustrating an embodiment a focus plane distance and a focus plane distance range. A first axis (e.g., y-axis) 402 represents a focus plane distance, and a second axis (e.g., x-axis) 404 represents a focus plane distance setting. A first curve 406 represents a setting of the focus plane distance, a second curve 408 represents a far focus plane distance, and a third curve 410 represents a near focus plane distance. If a hypothetical vertical line is drawn to intersect the first, second, and third curves 406, 408, and 410, the setting of the focus plane distance is the first axis 402 value of the intersection of the vertical line and the first curve 406, the far focus plane distance is the first axis 402 value of the intersection of the vertical line and the second curve 408, and the near focus plane distance is the first axis 402 value of the intersection of the vertical line and the third curve 410. Thus the range of acceptable estimated focus plane distances are the values on a vertical line (read from the first axis 402) between the second curve 408 and the third curve 410 for a selected focus plane distance on the second axis 404.

It should be noted that the first, second, and third curves 406, 408, and 410 of FIG. 4 may be generated using the hyperfocal equations described previously. Such hyperfocal equations may be used to determine the near focus plane distance Dₙ, and the far focus plane distance D_{f}, as a function of distance s to which the lens is set, and a selected CoC limit c, for a representative lens having a focal length f, and an f-number N, as previously defined. As may be appreciated, the near focus plane distance and/or the far focus plane distance may be determined using any suitable method, which may be different than the hyperfocal distance calculations presented. For example the near and far focus plane distance bounds may be selected, based on an empirical evaluation of a lens system, and/or based on a lens system calibration.

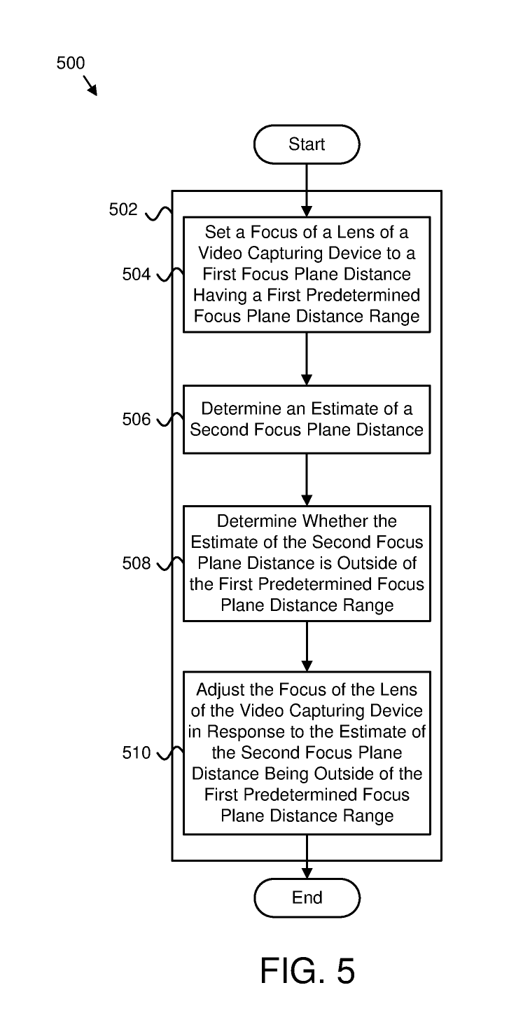

FIG. 5 is a schematic flow chart diagram illustrating an embodiment of a method 500 for capturing video. In some embodiments, the method 500 is performed by an apparatus, such as the information handling device 102. In other embodiments, the method 500 may be performed by a module, such as the video capture module 114. In certain embodiments, the method 500 may be performed by a processor executing program code, for example, a microcontroller, a microprocessor, a CPU, a GPU, an auxiliary processing unit, a FPGA, or the like.

The method 500 may include capturing 502 a video using a video capturing device (e.g., information handling device 102). In certain embodiments, the video capture module 114 may capture 502 the video using the video capturing device. In some embodiments, capturing 502 the video includes focusing the lens using autofocus.

Capturing 502 the video may include setting 504 a focus of a lens 116 of the video capturing device to a first focus plane distance having a first predetermined focus plane distance range. In certain embodiments, the lens focus positioning module 202 may set 504 the focus of the lens 116 of the video capturing device to the first focus plane distance having the first predetermined focus plane distance range. In various embodiments, setting 504 the focus of the lens 116 of the video capturing device to the first focus plane distance includes determining the first focus plane distance.

In one embodiment, a variable used to determine the first predetermined focus plane distance range is a CoC variable. In some embodiments, capturing 502 the video includes adjusting the CoC variable in response to historical data. In various embodiments, the first predetermined focus plane distance range includes a range from a near focus plane distance to a far focus plane distance. In such embodiments, the near focus plane distance and the far focus plane distance may be determined based on the first focus plane distance. In one embodiment, the near focus plane distance and the far focus plane distance may be determined using a lookup table.

In certain embodiments, capturing 502 the video may include determining 506 an estimate of a second focus plane distance. In one embodiment, the focus plane distance determination module 204 may determine 506 the estimate of the second focus plane distance. In some embodiments, determining 506 the estimate of the second focus plane distance includes not adjusting the focus of the lens 116. In certain embodiments, determining 506 the estimate of the second focus plane distance includes using phase detection to determine the estimate of the second focus plane distance.

In various embodiments, capturing 502 the video may include determining 508 whether the estimate of the second focus plane distance is outside of the first predetermined focus plane distance range. In one embodiment, the in-range determination module 206 may determine 508 whether the estimate of the second focus plane distance is outside of the first predetermined focus plane distance range.

In one embodiment, capturing 502 the video may include adjusting 510 the focus of the lens 116 of the video capturing device in response to the estimate of the second focus plane distance being outside of the first predetermined focus plane distance range, and the method 500 may end. In certain embodiments, the lens focus adjustment module 208 may adjust 510 the focus of the lens 116 of the video capturing device in response to the estimate of the second focus plane distance being outside of the first predetermined focus plane distance range. In some embodiments, adjusting 510 the focus of the lens 116 of the video capturing device includes adjusting the focus of the lens 116 based on the estimate of the second focus plane distance.

In certain embodiments, the first and second focus plane distances are determined by detecting a distance between the lens of the video capturing device and one or more of a selected person and a selected object. In such embodiments, the focus of the lens 116 does not change if the one or more of the selected person and the selected object is outside of a lens field of view.

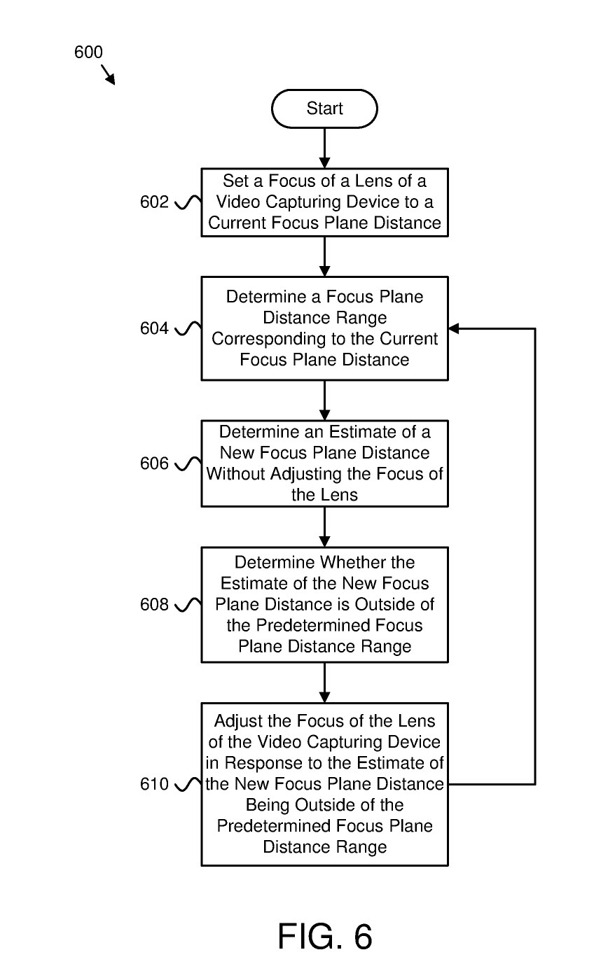

FIG. 6 is a schematic flow chart diagram illustrating another embodiment of a method 600 for capturing video. In some embodiments, the method 600 is performed by an apparatus, such as the information handling device 102. In other embodiments, the method 600 may be performed by a module, such as the video capture module 114. In certain embodiments, the method 600 may be performed by a processor executing program code, for example, a microcontroller, a microprocessor, a CPU, a GPU, an auxiliary processing unit, a FPGA, or the like.

The method 600 may include setting 602 a focus of a lens 116 of the video capturing device to a current focus plane distance. In certain embodiments, the lens focus positioning module 202 may set 602 the focus of the lens 116 of the video capturing device to the current focus plane distance. In various embodiments, the method 600 may include determining 604 a focus plane distance range corresponding to the current focus plane distance. In some embodiments, the focus plane range determination module 304 may determine 604 the focus plane distance range corresponding to the current focus plane distance.

In certain embodiments, the method 600 may include determining 606 an estimate of a new focus plane distance without adjusting the focus of the lens 116. In one embodiment, the focus plane distance determination module 204 may determine 606 the estimate of the new focus plane distance.

In various embodiments, the method 600 may include determining 608 whether the estimate of the new focus plane distance is outside of the predetermined focus plane distance range. In one embodiment, the in-range determination module 206 may determine 608 whether the estimate of the new focus plane distance is outside of the predetermined focus plane distance range.

In one embodiment, the method 600 may include adjusting 610 the focus of the lens 116 of the video capturing device in response to the estimate of the new focus plane distance being outside of the predetermined focus plane distance range, and the method 600 may return to determining 604 the focus plane distance range. In certain embodiments, the lens focus adjustment module 208 may adjust 610 the focus of the lens 116 of the video capturing device in response to the estimate of the new focus plane distance being outside of the predetermined focus plane distance range.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus comprising:
a video capturing device having a lens;
a processor;
a memory that stores code executable by the processor to:
capture a video using the video capturing device, wherein capturing the video comprises:
setting a focus of the lens to a first focus plane distance having a first predetermined focus plane distance range;
determining an estimate of a second focus plane distance;
determining whether the estimate of the second focus plane distance is outside of the first predetermined focus plane distance range; and
adjusting the focus of the lens of the video capturing device in response to the estimate of the second focus plane distance being outside of the first predetermined focus plane distance range.

2. The apparatus of claim 1, wherein setting the focus of the lens of the video capturing device to the first focus plane distance comprises determining the first focus plane distance.

3. The apparatus of claim 1, wherein capturing the video comprises adjusting a measure of acceptable sharpness used to determine the first predetermined focus plane distance range in response to historical data.

4. The apparatus of claim 3, wherein the measure of acceptable sharpness used to determine the first predetermined focus plane distance range is a variable.

5. The apparatus of claim 4, wherein the variable is a circle of confusion variable.

6. The apparatus of claim 1, wherein the first predetermined focus plane distance range comprises a near focus plane distance to a far focus plane distance.

7. The apparatus of claim 6, wherein the near focus plane distance and the far focus plane distance are determined based on the first focus plane distance.

8. The apparatus of claim 1, wherein determining the estimate of the second focus plane distance comprises using phase detection to determine the estimate of the second focus plane distance.

9. A method comprising:
capturing a video using a video capturing device, wherein capturing the video comprises:
setting, by use of a processor, a focus of a lens of the video capturing device to a first focus plane distance having a first predetermined focus plane distance range;
determining, by use of the processor, an estimate of a second focus plane distance;
determining, by use of the processor, whether the estimate of the second focus plane distance is outside of the first predetermined focus plane distance range; and
adjusting, by use of the processor, the focus of the lens of the video capturing device in response to the estimate of the second focus plane distance being outside of the first predetermined focus plane distance range.

10. The method of claim 9, wherein capturing the video comprises focusing the lens using autofocus.

11. The method of claim 9, wherein setting the focus of the lens of the video capturing device to the first focus plane distance comprises determining the first focus plane distance.

12. The method of claim 9, wherein capturing the video comprises adjusting a measure of acceptable sharpness used to determine the first predetermined focus plane distance range in response to historical data.

13. The method of claim 12, wherein the measure of acceptable sharpness used to determine the first predetermined focus plane distance range is a variable.

14. The method of claim 13, wherein the variable is a circle of confusion variable.

15. The method of claim 9, wherein the first predetermined focus plane distance range comprises a range from a near focus plane distance to a far focus plane distance.

16. The method of claim 15, wherein the near focus plane distance and the far focus plane distance are determined based on the first focus plane distance.

17. The method of claim 15, wherein the near focus plane distance and the far focus plane distance are determined using a lookup table.

18. The method of claim 9, wherein determining the estimate of the second focus plane distance comprises not adjusting the focus of the lens.

19. The method of claim 9, wherein determining the estimate of the second focus plane distance comprises using phase detection to determine the estimate of the second focus plane distance.

20. The method of claim 9, wherein adjusting the focus of the lens of the video capturing device comprises adjusting the focus of the lens based on the estimate of the second focus plane distance.

21. The method of claim 9, wherein the first and second focus plane distances are determined by detecting a distance between the lens of the video capturing device and one or more of a selected person and a selected object.

22. The method of claim 21, wherein the focus of the lens does not change if the one or more of the selected person and the selected object is outside of a lens field of view.

23. A program product comprising a computer readable storage medium that stores code executable by a processor, the executable code comprising code to perform:
capturing a video using a video capturing device, wherein capturing the video comprises:
setting a focus of a lens of the video capturing device to a first focus plane distance having a first predetermined focus plane distance range;
determining an estimate of a second focus plane distance;
determining whether the estimate of the second focus plane distance is outside of the first predetermined focus plane distance range; and
adjusting the focus of the lens of the video capturing device in response to the estimate of the second focus plane distance being outside of the first predetermined focus plane distance range.
